(19) United States
(12) Patent Application Publication
(10) Pub. No.: US 2010/0239956 A1
(43) Pub. Date: Sep. 23, 2010

(54) Unit for a Fuel Cell System, and a Fuel Cell System

(75) Inventors: Andreas Knoop, Esslingen (DE); Dietmar Mirsch, Kirchheim (DE); Hans-Joerg Schabel, Reutlingen (DE)

Correspondence Address: CROWELL & MORING LLP;INTELLECTUAL PROPERTY GROUP, P.O. BOX 14300, WASHINGTON, DC, 20044-4300, US

(73) Assignees: DAIMLER AG, Stuttgart (DE); FORD GLOBAL TECHNOLOGIES, LLC, Dearborn, MI (US)

(21) Appl. No.: 12/669,772

(22) PCT Filed: May 28, 2008
(86) PCT No.: PCT/EP2008/004226

§ 371 Date: May 19, 2010

(30) Foreign Application Priority Data
Jul. 17, 2007 (DE) 10 2007 033 203.5

(51) Int. Cl. H01M 8/02; F15D 1/00; F16K 31/02

(52) U.S. Cl. 429/514; 137/561 R; 251/129.01

(57) ABSTRACT

A flow unit such as may be provided as a recirculation device for an anode circuit of a fuel cell system has at least one moving element by which a two-phase flow with a liquid phase can be conveyed. At least one separator is arranged in or adjacent to the unit.

### BACKGROUND AND SUMMARY OF THE INVENTION

This application is a national stage of PCT International Application No. PCT/EP2008/004226, filed May 28, 2008, which claims priority under 35 U.S.C. §119 to German Patent Application No. 10 2007 033 203.5, filed Jul. 17, 2007, the entire disclosure of which is herein expressly incorporated by reference.

The invention relates to a flow unit having at least one moving element, in particular a recirculation unit, for conveying a two-phase flow with a liquid phase, and to a fuel cell system having such a unit.

A fuel cell system comprises one or more fuel cells which are connected in series and/or in parallel to form a fuel cell stack. Hydrogen is normally used as the fuel (also referred to as the anode gas); however. it is also known to use methane, methanol or glucose solution. The fuel (hydrogen) is fed into the fuel cell stack at an inlet on an anode side of the fuel cell or the fuel cell stack. Anode off-gases emerge at an outlet from the fuel cell (or the fuel cell stack) and, when using hydrogen, comprise, inter alia, unconsumed hydrogen as well as water. The unconsumed fuel can be made available again at the inlet via a recirculation circuit. The recirculation circuit for this purpose has a recirculation unit, for example a pump.

If there is water in the anode off-gas, then at temperatures below the freezing point of water (that is, temperatures below 0° C.), there is a risk of the recirculation unit freezing up. Particularly in the case of so-called frozen starting (that is, starting without preheating), this can then lead to damage of the recirculation unit.

It is therefore known, for example from Published U.S. Patent Application No. 2004/0219401 A1, to purge the recirculation unit with a dry purging gas during shutting down of the fuel cell system in order to remove any water that is present there. For this purpose, a connecting line is provided between an air compressor, which produces compressed air on a cathode side of the fuel cell stack, and a purging gas inlet on the unit.

One object of the present invention is to provide a unit which prevents, or at least reduces, such freezing up.

A further object of the invention is to provide a fuel cell system having such a unit.

This and other objects and advantages are achieved by the flow unit according to the invention, which has at least one moving element by which a two-phase flow can be conveyed, with at least one separator being arranged in and/or adjacent to the unit. Integration of the separator into the unit allows a particularly compact design. In this case, depending on the field of application of the unit, the weight can be reduced by about 2 kg and the volume can be reduced by about 11% of the associated system. This compact design is therefore particularly advantageous for mobile systems (for example, in motor vehicles). By way of example, the flow unit according to the invention may be a pump, a compressor, a turbine, a fan or the like. The separator is designed such that it is possible to avoid at least relatively large amounts of condensate (in particular, relatively large water droplets), which can cause moving parts of the unit to freeze up. In this case, there is no need for additional valves and/or sensors.

In one embodiment of the invention, the unit is a recirculation unit (particularly, a compressor and/or a fan), for an anode circuit of a fuel cell system. By way of example, the unit may be an axial, radial or side-channel compressor.

In one embodiment of the unit, the separator is designed using the geometry of the unit, steady-state and/or dynamic flow trajectories of a liquid phase of the two-phase flow. This allows an optimum geometry and an optimum arrangement of the separator on the unit, for deposition of relatively large amounts of condensate or water.

In a further embodiment of the unit, the separator has an outlet with an outlet valve. The outlet is in this case likewise provided in and/or adjacent to the unit, thus forming a compact design.

According to a feature of the invention, the outlet valve can be provided with closed-loop and/or open-loop control, particularly electronic closed-loop and/or open-loop control, which makes it possible to output the deposited condensate as required, for example when a certain amount of water is exceeded.

In a further refinement of the invention, the separator has an associated sensor for detection of a liquid content or filling level. For example, the sensor may be a so-called level sensor for the detection of a filling level. In other refinements, it is possible to dispense with a sensor, depending on the operating procedure. However, a corresponding sensor allows the outlet valve in the outlet to be controlled particularly reliably.

The invention also provides a fuel cell system that includes a flow unit of the type described. The unit is preferably integrated in an anode circuit of the fuel cell system. However, other applications are also feasible.

In one embodiment of the fuel cell system, a second separator is provided in the anode circuit, so that a condensate deposited on the first separator can be output via an outlet from the second separator. The second separator may be a conventional separator upstream of the unit. Combination with a unit according to the invention makes it possible to make the separator smaller, so as to save physical space. The condensate which emerges from the integrated separator can be introduced into the second separator, and output via its outlet, using the pressure difference in the system.

In another embodiment of the fuel cell system according to the invention, a third separator is provided, which has an inlet for a purging gas, as well as an outlet that is connected to the inlet of the unit. For example, the third separator may be arranged and/or operated as described in Published U.S. Patent Application No. 2004/0219401 A1.

Further advantages of the invention will become evident from the following description of one exemplary embodiment of the invention, which is illustrated schematically in the drawings. The same reference symbols are used for the same or similar components in the drawings. All of the features and/or advantages which are evident from the claims, the description or the drawings, including design details, physical arrangements and method steps, may be significant to the invention both in their own right and in widely differing combinations.

### BRIEF DESCRIPTION OF THE DRAWINGS

FIG. 1 is a schematic block diagram of a fuel cell system according to the invention;

FIG. 2 is a partially cut-open perspective side view of one exemplary embodiment of a unit according to the invention; and

FIG. 3 is a perspective plan view of the component shown in FIG. 2.

### DETAILED DESCRIPTION OF THE DRAWINGS

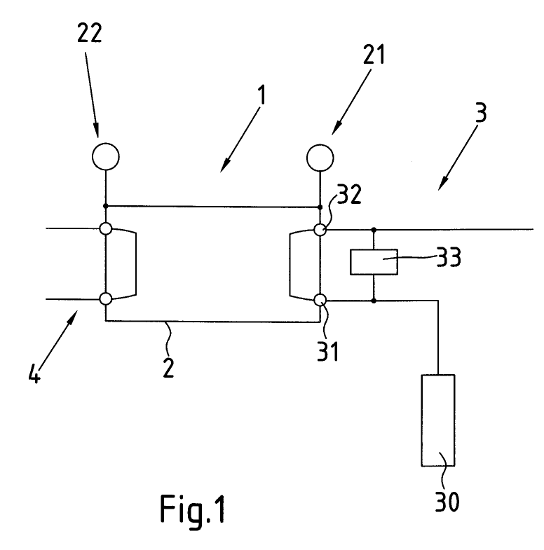

FIG. 1 shows, schematically, a block diagram of one exemplary embodiment of a fuel cell system 1 according to the invention. The fuel cell system 1 has a fuel cell stack 2 which is formed from a plurality of fuel cells that are electrically connected in series and/or in parallel. Anode sides of individual fuel cells in the fuel cell stack 2 provide the anode side 21 of the fuel cell stack 2, while the cathode sides of the fuel cells likewise provide the cathode side 22 of the fuel cell stack. Anode and cathode circuits 3, 4, which are illustrated in a simplified schematic form, are arranged respectively on the anode side 21 and on the cathode side 22. The anode circuit 3, which is illustrated in a simplified form, has a fuel reservoir 30, with the fuel (for example hydrogen), being supplied to the fuel cell stack 2 via an inlet 31. Anode off-gas is output via an outlet 32 from the fuel cell stack 2. According to the invention, a recirculation unit 33 is provided, through which at least some of the anode off-gas can be fed back to the inlet 31 again.

According to the invention, a separator (not shown in FIG. 1) is integrated in the recirculation unit 33, so that a condensate (such as water), can be deposited in the recirculation unit 33. Relatively large water droplets which can cause a moving part of the recirculation unit, for example an impeller of a recirculation fan, to freeze up are thus avoided.

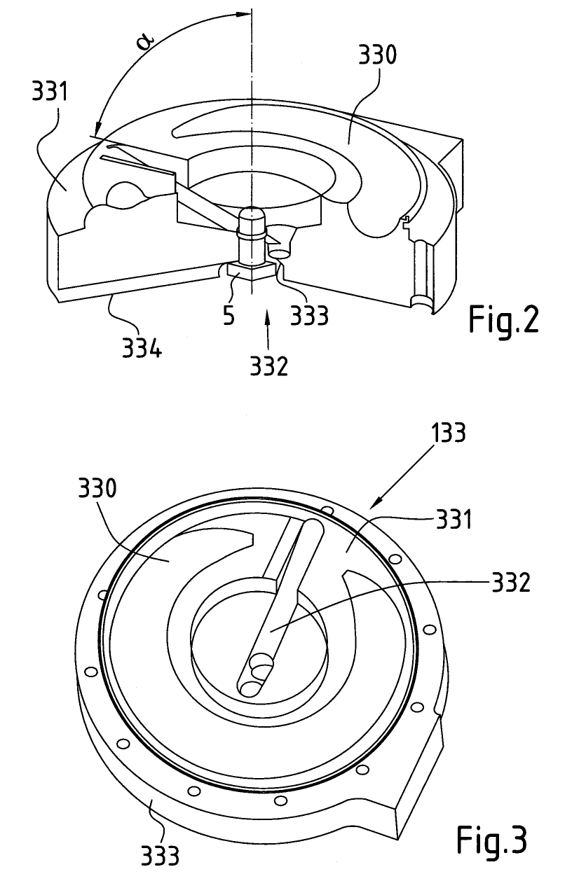

FIGS. 2 (partially broken away perspective side view) and 3 (perspective plan view) show, schematically, a housing cover 133 for the recirculation unit 33 according to the invention which, in the illustrated embodiment, is in the form of a side-channel fan or side-channel compressor. A side channel 330 is formed in the housing cover 133. The side-channel compressor sucks in a fluid (a gas, a liquid or a two-phase flow), with the pressure of the fluid being increased by a series of vortices which are produced by centrifugal force in the side channel 330. As can be seen in FIG. 3, the side channel 330 is not circumferential, but is interrupted. According to the invention, a channel 331 is formed as a separator (in the radial direction) in the interruption in the side channel 330. The channel 331 is inclined at an angle of between 0° and 90° with respect to a rotation axis A or axial direction of the side-channel compressor.

During operation, a condensate, such as water, which is contained in a two-phase flow conveyed by the side-channel compressor, is deposited with a specific deposition degree, depending on the operating point. The deposited condensate is collected in an area of a centre 332 of the housing cover 133, and is output via an outlet in the form of an opening 333. The opening 333 can open into a line, (not shown), for this purpose. The opening 333 and/or the line may also have an outlet valve (not illustrated), with the outlet valve being opened in order to output the condensate when a definable amount of deposited condensate is exceeded. Furthermore, a sensor 5 for detection of a liquid content is provided in the centre 332 of the housing cover 133. The sensor 5 in the illustrated exemplary embodiment is in the form of a level sensor for detection of a filling level. In the illustrated housing cover 133, a groove 334 is provided, through which a cable (not shown), can be routed for controlling and/or reading the sensor.

A separator in this form replaces a separate separator, which is provided upstream of the unit 33 in the fuel cell system 1 as shown in FIG. 1. This makes it possible to reduce considerably the total weight of the fuel cell system 1 and the total volume of the fuel cell system 1. However, in other embodiments, a separator can also be provided upstream of the unit 33 shown in FIG. 1, although this may be smaller than that in conventional systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A flow unit comprising:
at least one moving element for conveying a two-phase flow with a liquid phase;
at least one first separator arranged in or adjacent to the flow unit;
a second separator provided in the anode circuit, whereby a condensate which is deposited on the first separator can be output via an outlet from the second separator; and
a third separator having an inlet for a purging gas, an outlet of the third separator being connected to the inlet of the unit.

11. The flow unit according to claim 10, wherein the flow unit is a recirculation unit for an anode circuit of a fuel cell system.

12. The flow unit according to claim 10, wherein the separator is designed based on one of the geometry of the unit, steady-state, and dynamic flow trajectories of a liquid phase of the two-phase flow.

13. The flow unit according to claim 10,wherein the first separator has an outlet with an outlet valve.

14. The flow unit according to claim 13, wherein the outlet valve is electronically controllable.

15. The flow unit according to claim 10, wherein the first separator has an associated sensor for detection of a liquid content.

16. The fuel cell system comprising the flow unit according to claim 10.
